(19) United States
(12) Patent Application Publication
(10) Pub. No.: US 2025/0307328 A1
(43) Pub. Date: Oct. 2, 2025

(54) DYNAMIC THREAD STATES

(71) Applicant: Microsoft Technology Licensing, LLC, Redmond, WA (US)

(72) Inventor: Felix G.T.I. ANDREW, Seattle, WA (US)

(73) Assignee: Microsoft Technology Licensing, LLC, Redmond, WA (US)

(21) Appl. No.: 18/621,796

(22) Filed: Mar. 29, 2024

(51) Int. Cl. G06F 16/9536; G06F 3/0481; G06F 3/04842; H04L 51/216

(52) U.S. Cl. CPC G06F 16/9536; G06F 3/0481; H04L 51/216; G06F 3/04842

(57) ABSTRACT

Systems and methods for capturing the dynamic state of a thread. A query may be received at an application. The query is processed at the language model to generate a response. The query and the response may be used as input to a generative AI model for generating a thread descriptor that is representative of a current state of the thread. This process may be iteratively repeated as additional turns are received in the thread such that the current state of the thread is represented by the thread descriptor even when the topic or subject matter of the thread diverges.

### BACKGROUND

Interactions with generative artificial intelligence (AI) models may often occur in a chat-based format. For instance, natural language inputs are provided to a chat interface. Those natural language inputs are combined into a prompt that is provided to the AI model to process. The output of the AI model is then provided as a response to the natural language inputs. These input/output pairs may continue for several turns as part of a thread or pseudo-conversation with the AI model.

It is with respect to these limitations and other considerations that examples have been made. In addition, although relatively specific problems have been discussed, it should be understood that the examples should not be limited to solving the specific problems identified in the background.

### SUMMARY

Examples described in this disclosure relate to systems and methods for capturing dynamic states of one or more threads. For example, an application having a chat interface may be launched on a computing device. A query is received at the application and provided as input to a language model, such as a generative artificial intelligence (AI) model. The generative AI model processes the query and generates a response for the query. The query and the response form a turn of a thread, and the thread is in a first state after receiving the most-recent query and corresponding response.

The first state may be captured and represented through the generation of thread descriptors, which may include data such a thread title, a thread synopsis, and/or a thread image that is representative of the first state of the thread. The thread descriptors are formed by incorporating the query and/or the response into a descriptor prompt that also includes static instructions for generating the thread descriptors. The descriptor prompt is provided to a generative AI model, which processes the descriptor prompt and generates the thread descriptors. One or more of the generated thread descriptors may then be surfaced with the ongoing thread and/or with a selectable thread element that can be selected to return to the corresponding state of the thread.

As further turns in the thread are received, new states of the thread are formed, and the topic and/or subject matter of the thread may diverge or wander from the initial topic or topics from prior states. Accordingly, at a subsequent state (e.g., after additional turns), an updated descriptor prompt is generated that includes the more recent queries and/or response. The updated descriptor prompt also includes the static instructions for generating the thread descriptors. The generative AI model then processes the updated descriptor prompt to generate updated thread descriptors. The updated thread descriptors are then surfaced, such as by replacing the previously generated thread descriptors. As a result, the thread descriptors remain accurate as to the current state of the thread.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

The present disclosure is illustrated by way of example by the accompanying figures, in which like references indicate similar elements. Elements in the figures are illustrated for simplicity and clarity and have not necessarily been drawn to scale.

FIG. 1 depicts a block diagram of a system in which a dynamic thread-representation system is implemented according to an example.

FIG. 2 depicts a block diagram of example components of a dynamic thread-representation system.

FIG. 3A depicts an example interface with selectable thread elements.

FIG. 3B depicts an example interface for providing chat functionality.

FIGS. 4A-4C depict example methods for capturing dynamic states of one or more threads.

FIG. 5 is a block diagram illustrating example physical components of a computing device with which aspects of the disclosure may be practiced.

### DETAILED DESCRIPTION

As discussed briefly above, interactions with generative AI models may occur through a chat-based interface where the generative AI model supports, or provides, the chatbot functionality. As part of the chat, an input or query is received (often from a user) and a response is generated from an output of the AI model that processes the input. Each input-output pair may be considered a single “turn.” Multiple turns form a thread or conversation.

In some examples, each new input is processed based on context from prior turns of the conversation. For instance, the prior inputs and/or responses within the conversation can be used to provide context for generating a new response. As a specific example, when a new input query is received, an AI prompt is formed that includes the new input as well as contextual data (e.g., queries and/or responses from prior turns in the conversation). That AI prompt is then processed by the generative AI model to generate an output that is used to generate a response for the new input. This use of context can be particularly useful as it allows for the user to no longer have to repeat prior inputs and for responses to continue to be refined to the current topic or domain of the conversation. For this reason, some chat systems even allow for a user to return to a chat in the state at which the conversation last left off. Such a feature allows for preservation of prior context where available.

In many conversations, however, the linearity of the conversation may diverge or wander. For instance, a conversation about a first topic may gradually, or abruptly, change to a new topic where the prior context is no longer particularly useful for generating new responses. In addition, when a user returns to the chat, the subject matter of the chat may no longer be clear to the user. As one example, a conversation may begin as a discussion about steak dinners. The more the chat continues, the conversation may meander through wine pairings, wine-producing regions, flights to different countries, and hotels in their countries. At that point, the topic of steak dinners (and the context thereof) is no longer relevant to the current point of the conversation.

In some examples, a title for a conversation may automatically be generated based on the first few turns of conversation. Using the example above, the conversation may be initially titled with “Steak Dinners.” By the end of the conversation, however, that title is no longer representative of the current state of the conversation (which may be about hotels in Italy). Further, if a user is looking to return to the conversation at a later date, selecting the conversation titled “Steak Dinners” likely leads to confusion as the most recent turns in the conversation have little to no relationship to steak dinners.

The technology disclosed herein provides for solutions for accurately representing and storing a current state of a chat conversation, even one that wanders significantly from initial starting topic, via dynamic thread descriptors. Representations for multiple different conversations may also be generated to allow for a user to select and return to the most relevant conversation with the most accurate context to the description or representation of the chat. In addition, the technology generates multiple levels of detail for the representation, including a visual representation of the conversation that allows for a user to quickly navigate back to the conversation.

Examples described in this disclosure relate to systems and methods for generating a dynamic title for a chat-based thread, based on the content within the thread. In an example implementation, a title for a thread is generated in real-time capturing the state of the thread. The title may then be surfaced concurrently with the ongoing thread.

As an example, a query is received through the chat interface of an application, thereby starting a thread. A response is generated to that query. A title may then be generated from the query and response. The title may be generated from a generative AI model. In some examples, additional levels of detail for the thread may also be generated, such as a synopsis of the thread and/or a representative image for the thread. The title, synopsis, and/or representative image may be collectively referred to as thread-representation data or thread descriptors. Timestamp data may also be recorded for the thread (e.g., last interaction time, start time, end time). Updated thread descriptors may then be generated when the topic of the thread changes, such as based on a determination that a newly received query diverges (e.g., does not match) a topic or subject matter from a prior state of the thread.

The thread descriptors may then be stored and linked to the thread for which they were generated. In examples, multiple threads may be created and associated with a particular user (e.g., a single user may initiate multiple different threads). Thread descriptors are then generated for each of the threads. The thread descriptors are used to create selectable user interface (UI) representations for the respective threads. When a selection of a UI representation is selected, a chat interface is loaded with the data of the corresponding thread and the thread may be continued from the chat interface from the thread's prior state.

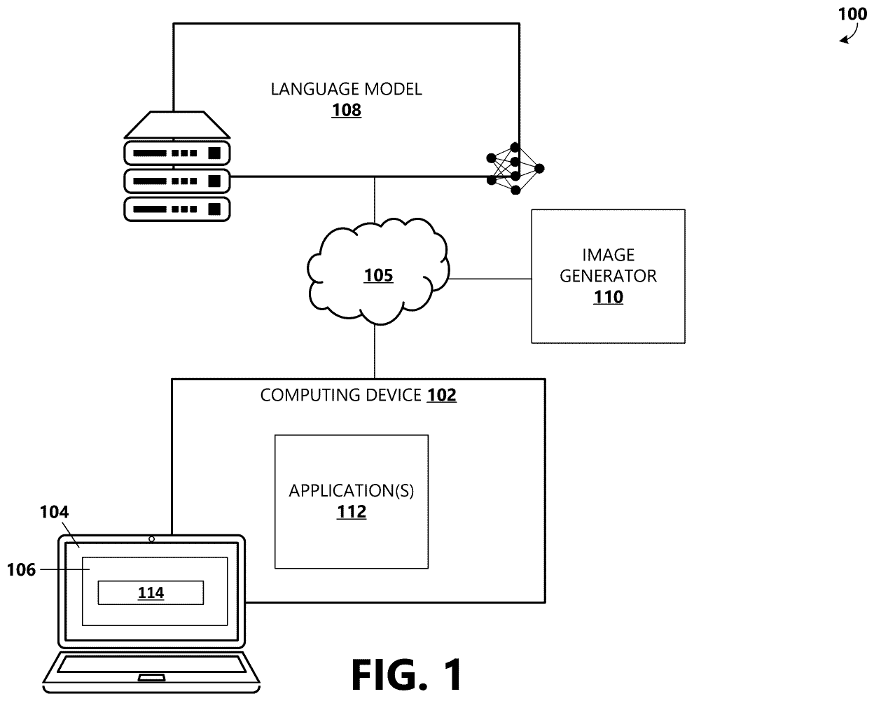

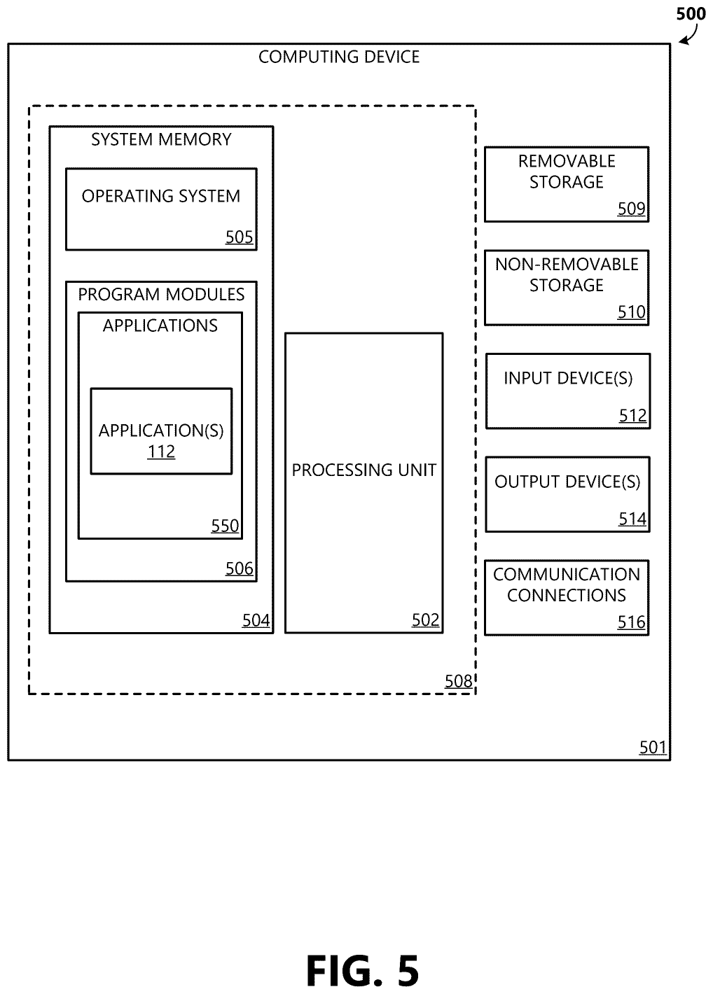

FIG. 1 is a block diagram of an example system 100 for generating a dynamic thread descriptor in accordance with an example. The example system 100, as depicted, is a combination of interdependent components that interact to form an integrated whole. Some components of the system 100 are illustrative of software applications, systems, or modules that operate on a computing device or across a plurality of computer devices. Any suitable computer device(s) may be used, including web servers, application servers, network appliances, dedicated computer hardware devices, virtual server devices, personal computers, a system-on-a-chip (SOC), or any combination of these and/or other computing devices known in the art. In one example, components of systems disclosed herein are implemented on a single processing device. The processing device may provide an operating environment for software components to execute and utilize resources or facilities of such a system. An example of processing device(s) comprising such an operating environment is depicted in FIG. 5. In another example, the components of systems disclosed herein are distributed across multiple processing devices. For instance, an input may be entered on a user device or client device and information may be processed on or accessed from other devices in a network, such as one or more remote cloud devices or web server devices.

The example system includes a computing device 102. The computing device 102 may take a variety of forms, including, for example, desktop computers, laptops, tablets, smart phones, wearable devices, gaming devices/platforms, virtualized reality devices/platforms (e.g., virtual reality (VR), augmented reality (AR), mixed reality (MR)), etc. The computing device 102 has an operating system that provides a graphical user interface (GUI) that allows users to interact with the computing device 102 via graphical elements, such as application windows (e.g., display areas), buttons, icons, and the like. For example, the graphical elements are displayed on a display screen 104 of the computing device 102 and can be selected and manipulated via user inputs received via a variety of input device types (e.g., keyboard, mouse, stylus, touch, spoken commands, gesture).

The computing device 102 includes a display 104 that generates a UI 106 according to an application 112 operating on the computing device. The UI 106 may include at least one input field 114 for receiving input from the user.

In examples, the computing device 102 includes a plurality of applications 112 for performing different tasks, such as communicating, information generation and/or management, data manipulation, visual construction, resource coordination, calculations, etc. According to an example implementation, the applications include at least one web browser. In examples, the web browser supports a chat feature that allows a user to interact with a chatbot, such as the BING CHAT interface or the COPILOT interface from Microsoft, through a chat agent interface. The chatbot may interact with a user through various communication means such as text or voice. An input field 114 of the chat interface is presented via the UI 106. The input field receives inputs for the chat feature, as discussed further below. The inputs may be received in the form of various modalities, such as text, image, and/or audio.

The computing device 102 is in communication with a language model 108 and an image generator 110. The computing device 102 communicates with the language model 108 and the image generator 110 via a network 105. For instance, the computing device 102 may communicate with the language model 108 and image generator 110 using one or a combination of networks 105 (e.g., a private area network (PAN), a local area network (LAN), a wide area network (WAN)). In some examples, the language model 108 is implemented in a cloud-based environment or server-based environment using one or more cloud resources, such as server devices (e.g., web servers, file servers, application servers, database servers), personal computers (PCs), virtual devices, and mobile devices. The hardware of the cloud resources may be distributed across disparate regions in different geographic locations.

The language model 108 may be a generative AI model, such as a large language model (LLM), a multimodal model, or other types of generative AI models. Example models may include the GPT models from OpenAI, BARD from Google, and/or LLaMA from Meta, among other types of generative AI models. The language model 108 may support the chat features discussed herein as well as the generation of the thread descriptors. In other examples, a first language model 108 supports the chat features and a second language model supports the generation of the thread descriptors.

In an example, an AI prompt is generated that includes the input query and a response for the input query of a thread. The prompt is then provided as input to the language model 108, which generates an output, in response to the prompt, that includes a thread descriptor for the thread. In some examples, a contextual history is created or accessed by the application 112 (e.g., by the web browser). Such contextual history may include prior searches, prior turns in a conversation, browsing history, and/or other context. Where such contextual history is available, the contextual history may also be incorporated into the prompt that is provided to the language model 108 to cause the generation of the thread descriptor. The thread descriptor included in the output from the language model 108 is then displayed, or caused to be displayed, as part of the current thread or as a UI representation of the thread.

According to example implementations, the language model 108 is trained to understand and generate sequences of tokens, which may be in the form of natural language (e.g., human-like text). In various examples, the language model 108 can understand complex intent, cause and effect, perform language translation, semantic search classification, complex classification, text sentiment, summarization, summarization for an audience, and/or other natural language capabilities.

In some examples, the language model 108 is in the form of a deep neural network that utilizes a transformer architecture to process the text it receives as an input or query. The neural network may include an input layer, multiple hidden layers, and an output layer. The hidden layers typically include attention mechanisms that allow the language model 108 to focus on specific parts of an input, and to generate context-aware outputs. Language model 108 is generally trained using supervised learning based on large amounts of annotated text data and learns to predict the next word or the label of a given text sequence.

The size of a language model 108 may be measured by the number of parameters it has. For instance, as one example of an LLM, the GPT-4 model from OpenAI has billions of parameters. These parameters may be weights in the neural network that define its behavior, and a large number of parameters allows the model to capture complex patterns in the training data. The training process typically involves updating these weights using gradient descent algorithms, and is computationally intensive, requiring large amounts of computational resources and a considerable amount of time. The language model 108 in examples herein, however, is pre-trained, meaning that the language model 108 has already been trained on the large amount of data. This pre-training allows the model to have a strong understanding of the structure and meaning of an input, which makes it more effective for the specific tasks discussed herein.

The language model 108 may operate as a transformer-type neural network. Such an architecture may employ an encoder-decoder structure and self-attention mechanisms to process the input (e.g., the text, image description or contextual history). Initial processing of the input data may include tokenizing the input into tokens that may then be mapped to a unique integer or mathematical representation. The integers or mathematical representations combined into vectors that may have a fixed size. These vectors may also be known as embeddings.

The initial layer of the transformer model receives the token embeddings. Each of the subsequent layers in the model may uses a self-attention mechanism that allows the model to weigh the importance of each token in relation to every other token in the input. In other words, the self-attention mechanism may compute a score for each token pair, which signifies how much attention should be given to other tokens when encoding a particular token. These scores are then used to create a weighted combination of the input embeddings.

In some examples, each layer of the transformer model comprises two primary sub-layers: the self-attention sub-layer and a feed-forward neural network sub-layer. The self-attention mechanism mentioned above is applied first, followed by the feed-forward neural network. The feed-forward neural network may be the same for each position and apply a simple neural network to each of the attention output vectors. The output of one layer becomes the input to the next. This means that each layer incrementally builds upon the understanding and processing of the data made by the previous layers. The output of the final layer may be processed and passed through a linear layer and a softmax activation function. This outputs a probability distribution over all possible tokens in the model's vocabulary. The token(s) with the highest probability is selected as the output token(s) for the corresponding input token(s).

According to examples, the system 100 further includes an image generator 110 that generates or retrieves an image that is representative a current state of a thread (e.g., conversation). For instance, data from the thread may be provided as input to the image generator 110 to cause the image generator 110 to generate an image representative of the thread. The image generator 110 may be in the form of a generative AI model as well that generates images from textual descriptions. One example of such a model is the DALL-E model from OpenAI.

In other examples, the image generator 110 forms a query based on the context of the thread and searches a database of images to identify an image that best matches the query. In either case, the returned image may be used as a thread descriptor as discussed further herein.

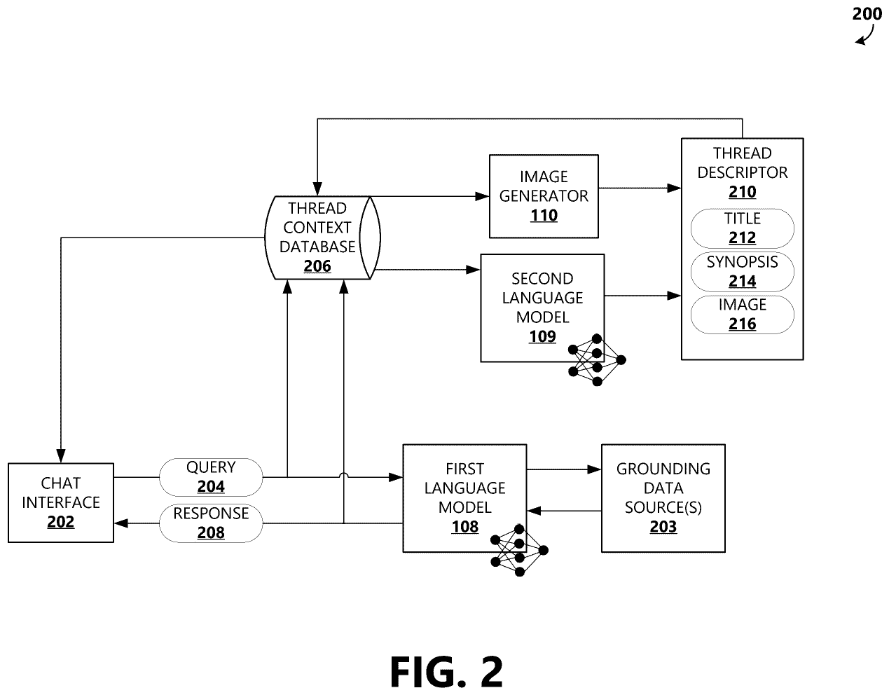

FIG. 2 is a block diagram of example components for a thread-descriptor generation system 200. System 200 includes chat interface 202 that receives a query 204 for generating response 208. In examples depicted, an application having chat interface 202 may be launched on computing device 102. The application may be a web browser, chatbot, messaging application, or any digital communication or collaborative system. A query 204 is received through the chat interface 202 of the application. The query 204 is an input intended for the chat session. The first query 204 may be the first input of a first turn of the thread.

The language model 108 receives the query 204 and processes the query 204 to generate response 208 to the input query 204. The process of generating the response 208 from the language model 108 may involve several operations, including incorporating the query 204 into an AI prompt, preprocessing, embedding, encoding, decoding, and postprocessing. As an initial stage, the query 204 is incorporated into a prompt that may include static instructions and other considerations for processing the query 204.

As an example embodiment, during preprocessing, the prompt with the query 204 is cleaned and tokenized into a sequence of words or sub-words. During embedding, each word or sub-word is mapped to a high-dimensional vector representation. During encoding, the vector representations are processed by the model to generate a hidden representation of the input query 204. During decoding, the hidden representation is used to generate the response sequence. Finally, during postprocessing, the response sequence is transformed into a human-readable format and provided back to the chat interface 202 as response 208.

The first query 204 and the first response 208 form the first turn of the current thread. As an example, a user may enter a query 204 such as “what is a good recipe for someone who is vegan?” The language model 108 may process the query 204 to generate response 208. The response 208 may include various information such as facts, opinions, recommendations, instructions, or explanations that matches the terms of the query 204.

In generating the response 208, the first language model 108 may also facilitate generation and/or retrieval of grounding data for responding to the query 204. For instance, upon processing the query 204, the first language model 108 may generate a secondary query (e.g., grounding query) that is executed against one or more grounding data sources 203. For instance, the grounding query may be a web search to find web pages that may be used to generate the response 208 to the query 204. In such examples, the grounding data source 203 includes the Internet. In other examples, the grounding data sources 203 may include file storage systems, image storage systems, or other types of storage systems that are capable of providing grounding data for generating the response 208. In response to the grounding query generated from the first language model 108, the grounding data sources 203 provide the corresponding grounding data. The generated grounding data and the query 204 may then be incorporated into another prompt that is provided to the first language model 108 for processing and generating the response 208 based on the grounding data and the query 204.

Multiple turns may then occur with queries 204 being received and corresponding responses 208 being generated. In addition to surfacing the queries 204 and responses 208, the received queries 204 and generated responses 208 are also stored in a thread-context database 206. The thread-context database 206 may also store grounding data that is received for generating the responses 208.

One or more thread descriptors 210 are generated from the data within the context database 206 (e.g., the queries and responses of the thread). To generate the thread descriptors 210, a descriptor prompt may be generated that includes static instructions for generating the particular thread descriptors 210 discussed below, such as a title 212, a synopsis 214, and/or an image 216. The descriptor prompt also includes the queries 204, responses 208, and/or grounding data from the current thread.

The descriptor prompt is then provided to a second language model 109 and/or an image generator 110. The second language model 109 may be similar to the first language model 108. In some examples, the second language model 109 is omitted and the first language model 108 also processes the descriptor prompt. When the second language model 109 processes the descriptor prompt, the output from the second language model 109 includes the thread descriptors 210 requested in the descriptor prompt.

The image generator 110 generates the image 216 based on the textual description in the descriptor prompt. For instance, as discussed above, the image generator 110 may be in the form of a generative AI model that generates images from textual descriptions, such as the DALL-E model from OpenAI. In other examples, the image generator 110 performs a search for an image based the terms in the descriptor prompt. For instance, the image generator 110 may perform a search over an image database to identify an image most closely matching the terms used in the descriptor prompt.

The thread descriptor 210 that is ultimately generated is a representation of the content within the thread. More than one thread descriptor 210 may be generated. For instance, a title 212 may be generated that is a single word or short phrase capturing the context of the content within the thread. For example, for a query 204 such as “what is a good recipe for someone who is vegan?,” and a corresponding response 208, the generated title 212 for the thread may be “Vegan Recipe” (or other words or phrases that captures the context of the content within the thread).

Another example thread descriptor 210 is a synopsis 214, which is a brief summary that captures the context of the content within the thread. The synopsis is generally longer and more detailed than the title. The synopsis 214 is similarly based on the queries 204, responses 208, and/or grounding data that is included in the descriptor prompt. The static instructions for generating the synopsis may include a word limit for the synopsis.

Another example thread descriptor 210 is an image 216, which is a visual representation of the content within the thread. For example, continuing with the vegan recipe topic above, the generated image 216 for the thread may be a visual representation of vegan recipes or other visual representation that captures the content of the thread.

In some examples, a background or theme color or image may also be generated based on the descriptor prompt. The background theme or color changes the background theme or color of the chat window. With the present technology the background or theme color or image can be based on the content of the current thread.

The generated thread descriptors 210 may then be stored within the context database 206 as associated with the current thread. For instance, multiple threads may be handled by the systems discussed herein. Each thread may be associated with a unique thread identifier (e.g., unique ID). The context from the thread and the generated thread descriptors are then stored with the unique ID for the particular thread for which they were generated.

While determining initial thread descriptors based on an initial turn (or few turns) of the thread is useful, the actual topic or subject of the thread may diverge or wander over time, as discussed above. Accordingly, the thread descriptors 210 may need to be periodically updated to remain accurate to the current content of the thread. In some examples, the updating may occur after a set number of turns in the thread or after set period of time, or a combination thereof. In other examples, an analysis of the current queries 204 and/or responses 208 may be performed to determine if a change in topic has occurred.

As an example, a first query 204 is received at an application on computing device 102 through chat interface 202, thereby initiating a turn to form a thread. The first query 204 may be received at language model 108 where a first response 208 is generated for the first query 204 thereby ending the turn. A thread descriptor 210 may be generated based on the first query 204 and the first response 208. The thread descriptor 210 may be surfaced and displayed to a user of the computing device 102. An additional query 204 for the thread may be subsequently received through the chat interface 202 and an additional response 208 may be subsequently generated.

An analysis may be performed on the additional query 204 and/or the additional response 208 to determine whether the additional query 204 diverges from the prior turn, a combination of prior turns, and/or the previously generated thread descriptor 210. Such a determination may be based on the embeddings of the additional query 204, the additional response 208, and/or combinations thereof. For instance, the additional query 204 may be received at a text-embedding generator such as Word2Vec, GloVe, and BERT. These techniques use neural networks to learn the relationships between words in a corpus of text and represent them as vectors in a high-dimensional space. The resulting vectors capture the semantic meaning of the words and may be used to compare the similarity between different pieces of text. The text-embedding generator may generate an embedding for the additional query 204 and/or additional response 208. The embeddings of the additional query 204 and/or the additional responses 208 may then be compared to embeddings generated for one or more of the prior queries 204, the prior responses 208, and/or the prior thread descriptors for the thread.

In other examples, the additional query 204 and/or the additional response 208 may be incorporated into a divergence prompt along with one or more of the prior queries 204, prior responses 208, and/or the prior thread descriptors 210. The divergence prompt also includes static instructions requesting a language model to determine if the thread has diverged from the prior topic. The divergence prompt is provided as input to the second language model 109 (or the first language model 108 or yet another language model) that processes the divergence prompts and generates an output that indicates whether the thread has diverged or not.

Where it is determined that the additional query 204 diverges for the previous turn or turns within a thread, the thread descriptor 210 may be updated based on the additional query 204 and/or additional response 208. The new or updated thread descriptors 210 may be generated similar to how the first thread descriptors were generated but for more recent queries 204 and/or responses 208. The updated thread descriptors 210 may then be stored as correlated with the current thread, and in some examples, the updated thread descriptors 210 replace the previous thread descriptors that were associated with the thread.

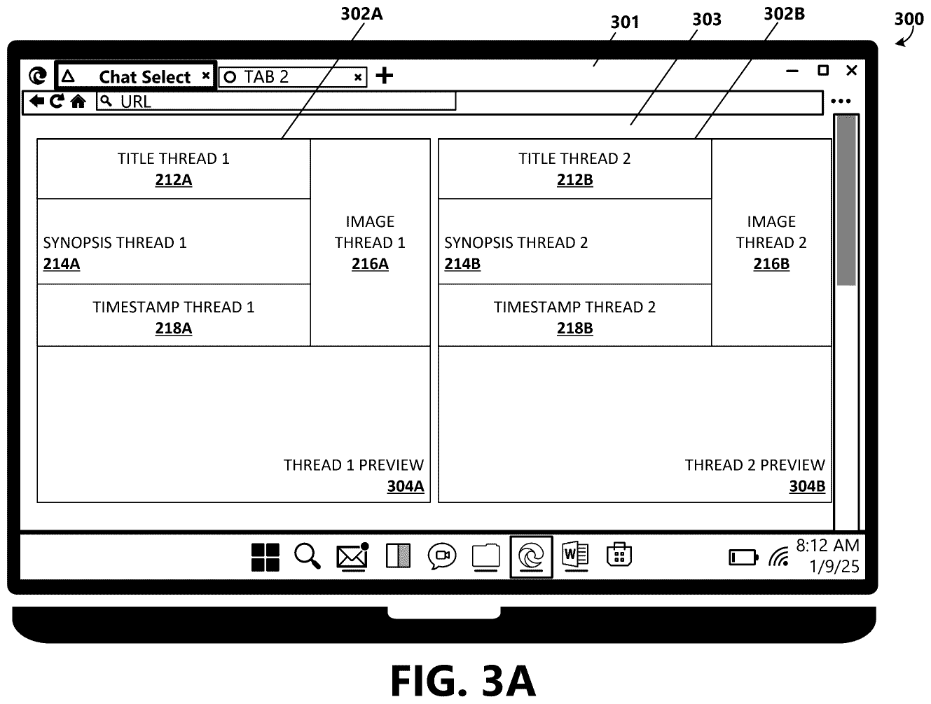

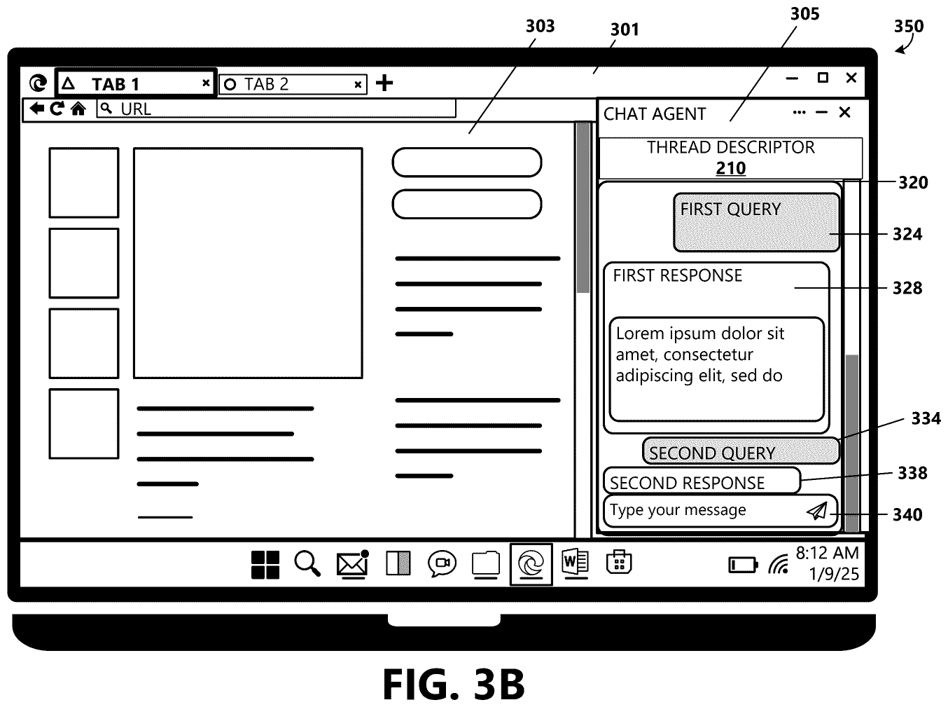

As discussed further herein, multiple threads may be associated with a particular user. For instance, a user may start and stop different threads at different points of time. Each of these threads may be associated with different unique IDs. At a later point in time after the user has ended or left a thread, the user may navigate back to that thread or another thread that has been previously established by the user. By having the correct, and current, thread descriptors associated with the thread ID, the user is more easily able to select the correct thread that is associated with the topic that the user desires to continue discussing. By selecting the correct thread, the continued conversation will continue to be more accurate as to the conversation because the language model is able to leverage the context (e.g., prior queries and responses) from the thread. The presentation of the different threads for selection with their thread descriptors may take different forms. One example is discussed below with reference to FIG. 3A.

FIG. 3A depicts an example interface 300 for selecting a thread to continue a conversation. The example interface 300 includes a web browser 301 that has been navigated to a “Chat Select” web page or resource. Within a main window 303 of the web browser is a thread selection interface that includes a first selectable UI element 302A for a first thread, which is referred to as the first thread element 302A, and a second selectable UI element 302B for a second thread, which is referred to as the second thread element 302B.

The first thread element 302A is associated with a first prior thread having a first unique ID. The second thread element 302B is associated with a second prior thread having a second unique ID. Each of the first thread element 302A and the second thread element 302B are populated with one or more thread descriptors that were generated for the corresponding thread. For example, the first thread element 302A includes the title 212A, the synopsis 214A, and the image 216A that were generated for the first thread. The first thread element 302A may also include a timestamp 218A for the first thread. The timestamp 218A may include different time-based information for the first thread, such as the last time the first thread was accessed, the duration of time for interaction with the second thread, and/or the time the third thread was started. In addition, a thread preview 304A for the first thread may be presented in the first thread element 302A. The thread preview 304A may include one or more of the last turns (e.g., most recent queries and responses) for the first thread.

The second thread element 302B is similar to the first thread element 302A, but the second thread element 302B includes data relating to a second thread. For example, the second thread element 302B includes the title 212B, the synopsis 214B, and the image 216B that were generated for the second thread. The second thread element 302B may also include a timestamp 218B for the second thread. The timestamp 218B may include different time-based information for the second thread, such as the last time the second thread was accessed, the duration of time for interaction with the second thread, and/or the time the third thread was started. In addition, a thread preview 304B for the second thread may be presented in the second thread element 302B. The thread preview 304B may include one or more of the last turns (e.g., most recent queries and responses) for the second thread.

Each of the first thread element 302A and the second thread element 302B, or portions thereof, are selectable. Upon selection, the corresponding thread is loaded and that user can continue interacting with the selected thread. For instance, upon selection of the first thread element 302A, the first thread is loaded and presented for continued interaction. As the user continues to interact with the first thread, the thread descriptors may be updated as the topic of the chat wanders. The first thread element 302A may then also be updated with the updated thread descriptors.

As an example, when a selectable thread element 302A-B is selected from within a web browser, a side pane of the web browser may be expanded to host the chat interface. One such example is shown in FIG. 3B, discussed below. In some examples, the selectable thread elements 302A-B may be displayed in a tab or side pane of the web browser, such as the side pane 305 of FIG. 3B, discussed below.

FIG. 3B depicts an example interface 350 for providing chat functionality. The example interface includes the web browser 301 and the main window 303 for the web browser. In the example depicted, the user has navigated the main window of the web browser to a different or new web page other than the chat selector page.

The example interface 350 further includes a side pane 305 that hosts the chat functionality. The side pane 305 may be hosted by the web browser 301, the operating system of the device, and/or another application of the device. The side pane 305 has been populated with the data from an ongoing thread. As an example, the side pane 305 may be populated with data from the first thread upon selection of the first thread element 302A, which may be accessed from the thread context database 206.

In the example depicted, the chat interface in the side pane 305 includes one or more of the thread descriptors 210 for the current thread (e.g., the first thread). The side pane 305 further includes a query/response section 320 that displays the prior queries and corresponding generated responses from the language model. For instance, the query/response section 320 includes a first query 324, a first response 328, a second query 334, and a second response 338. A query-input element 340 is also presented in the chat interface of the side pane 305 that receives new queries from the user.

As new queries are entered from the user and new responses are generated, updated thread descriptors 210 may also be generated, and the displayed thread descriptors 210 are similarly updated to reflect the current state of the thread. For instance, after a new query is entered in the query-input element 340, the thread descriptors 210 may also be updated.

In addition, as discussed further herein, the context of the current thread may be used to generate new responses from the language model. Continuing with the example of the first thread element 302A being selected and the chat interface being populated with data of the first thread, a new query may be entered into the query-input element 340. The system incorporates the new query into an AI prompt along with the static instructions to process the query. The AI prompt further includes context of the first thread, which may be in the form of prior queries and/or responses from the first thread. For instance, the AI prompt may include context in the form of the first query 324, the first response 328, the second query 334, and/or the second response 338. In other examples, the context may include a set number of recent turns from the thread. The language model then processes the AI prompt to generate a new response to the new query.

Due to the use of the context in generating new responses, a selection of the correct thread leads to more accurate and contextually relevant new responses without requiring re-entry of data from user. As an example, if the first thread relates to a topic of “Vegan Recipes” and the second thread relates to a topic of “Italian Travel,” the context for those threads is likely quite different. Resultantly, a new query in the first thread will result in a different response than the same new query being entered in the second thread. If the new query relates to continuing a conversation about vegan recipes, the response to the new query will likely be more contextually relevant and accurate if entered into the first thread rather than the second thread. Thus, having accurate and current thread descriptors becomes important for selection of a particular thread to continue the conversation.

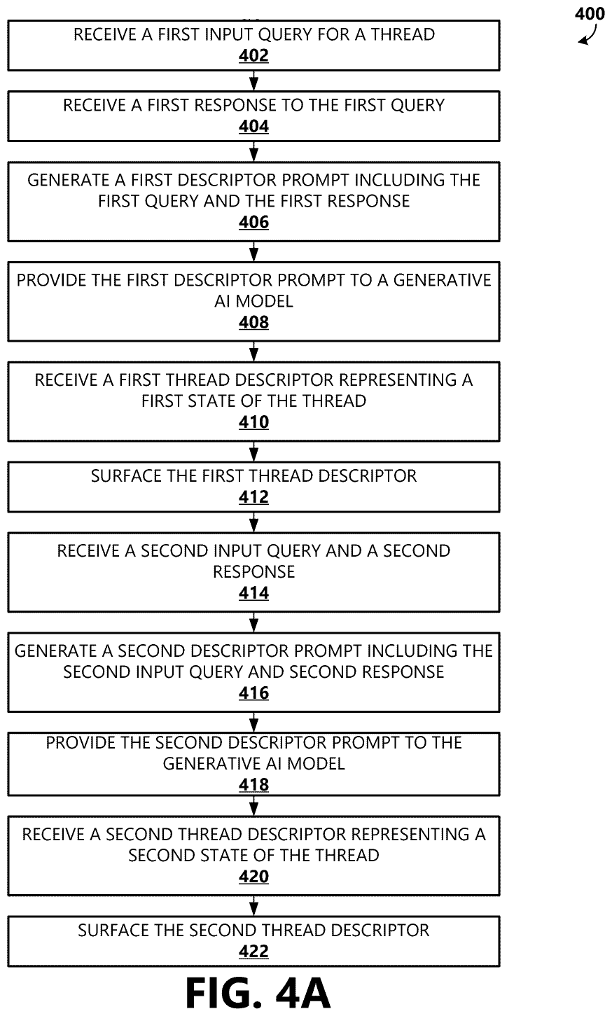

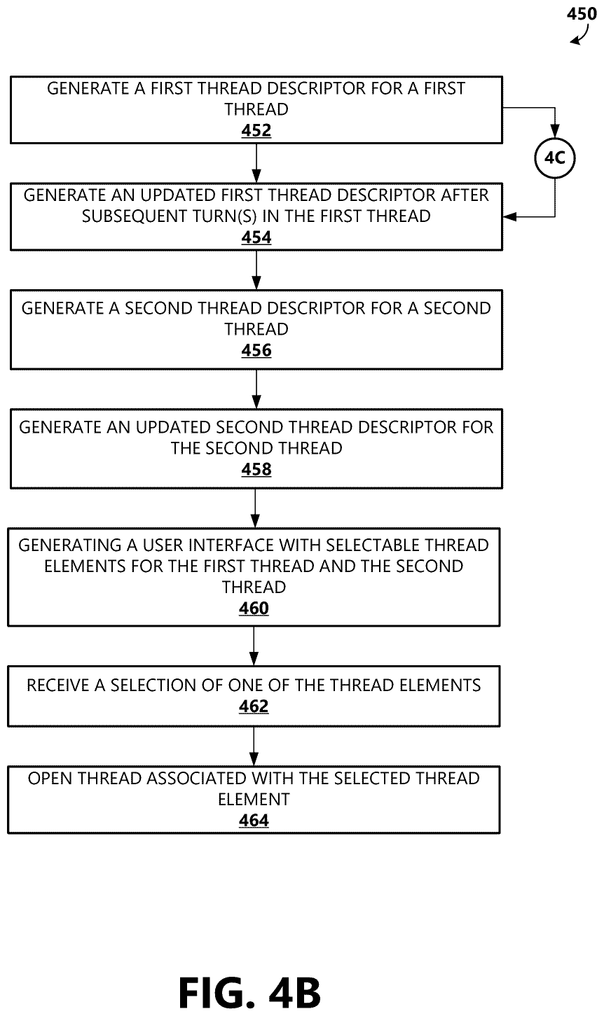

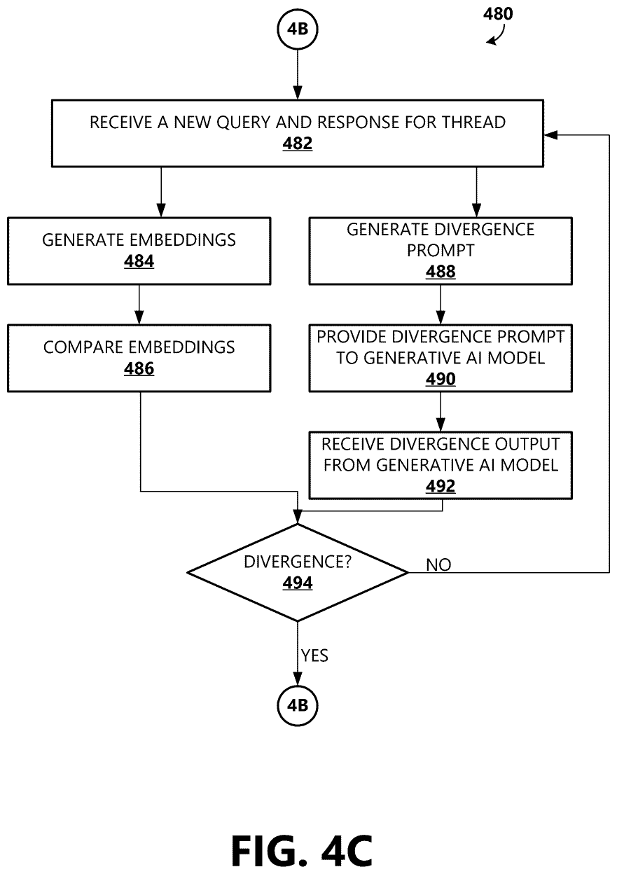

FIG. 4A depicts an example method 400 for capturing a dynamic state of a thread. At operation 402, a first input query is received for a thread. For example, a query is received from a user in a chat interface, such as a chat interface hosted by a web browser. At operation 404, a first response to the first query is received. The first response may be received from a language model that supports the chat feature. Generation of the first response may also be based on additional grounding data that was used by the language model. Such grounding data, or a portion thereof, may also be received as part of or with the first response.

At operation 406, a first descriptor prompt is generated that includes the first query and/or the first response. In some examples, the first descriptor prompt also includes at least a portion of the grounding data used to generate the first response. The first descriptor prompt also includes static instructions that instruct a generative AI model to generate one or more first thread descriptors for the thread. For instance, the requested first thread descriptors may include any of the thread descriptors discussed herein, such as a thread title, synopsis, or image.

At operation 408, the first descriptor prompt is provided as input to a generative model. The generative AI model processes the first descriptor prompt and generates the requested one or more first thread descriptors. The generated first thread descriptors are received at operation 410. The generated first thread descriptors are representative of a first state of the thread after the first input query and the first input response have been received.

The first thread descriptors are then surfaced at operation 412. Surfacing the first thread descriptors may include displaying the thread descriptors within the chat interface concurrently with the first input query and the first response. For instance, where the thread descriptor includes a title, the title may be displayed above a query/response section of the chat interface.

At operation 414, a second input query and a second response (e.g., a response to the second input query) are received. The second input query and response may be received similar to the first input query and response. For instance, the second input query may be received from the chat interface from a user and the corresponding response may be received from the language model.

At operation 416, a second descriptor prompt including the second input query and the second response is generated. The second descriptor prompt may also include at least a portion of the grounding data used to generate the second response. The second descriptor prompt may also include the same or similar static instructions as the first descriptor prompt. For instance, the static instructions include instructions for generating one or more second thread descriptors.

At operation 418, the second descriptor prompt is provided to the generative AI model. The generative AI model then processes the second descriptor prompt and generates the second thread descriptors. At operation 420, the second thread descriptors are received from the generative AI model. The second thread descriptors represent a second state of the thread after the second input query and the second response have been received.

In some examples, generating the second thread descriptors may include multiple calls to one or more generative AI models. For instance, one or more thread descriptors may be based on other thread descriptors. As an example, an image thread descriptor may be based on a synopsis thread descriptor and/or a title thread descriptor. In such an example, the second descriptor prompt includes instructions to generate the synopsis and/or title. The received synopsis and/or title is then incorporated into a third descriptor prompt that includes instructions for generating an image based on the synopsis and/or title. The third descriptor prompt is then provided to the generative AI model (which may be the same or different generative AI model used for generating the other thread descriptors). The generative AI model processes the third descriptor prompt and generates the requested image, which is then received by the application as part of the second thread descriptors.

At operation 422, one or more of the second thread descriptors are surfaced. The second thread descriptors may be surfaced in a similar manner as the first thread descriptors. In some examples, the second thread descriptors surfaced by replacing the previously surfaced first thread descriptors.

The method 400 may also be repeated for separate or new thread to generate dynamic thread descriptors for the additional thread. Such thread descriptors may be stored with the respective threads, as discussed herein.

FIG. 4B depicts another method 450 for capturing dynamic states of threads. At operation 452, a first thread descriptor is generated for a first thread in a first state (e.g., after a number of turns). The first thread descriptor may be generated as discussed herein, such as by performing operations 406-410 of method 400 described above. At operation 454, an updated first thread descriptor is generated for the first thread in a second state (e.g., after an additional number of turns). The updated first thread descriptor may be generated as discussed herein, such as by performing operations 416-420 of method 400 discussed above. Operation 454 may further include storing the updated first thread descriptor with the first thread.

The updated first thread descriptor may be generated after a set number of turns have been received after generation of the first thread descriptor generated in operation 406. In other examples, the updated first thread descriptor may be generated after a divergence in topic or subject matter of the thread has occurred. Determining a divergence may be determined by performing method 480 depicted in FIG. 4C.

Turning briefly to FIG. 4C and method 480, at operation 482 a new query and response are received in the first thread. A determination is then ultimately made as to whether the new query and/or response is indicative of a divergence from a prior topic or subject matter of the chat for which a thread descriptor was previously generated. The divergence may be analyzed by performing operations 484-486, which analyzes embeddings, and/or by performing operations 488-492, which leverages a generative AI model to identify the divergence.

At operation 484, one or more embeddings are generated for the new query and/or the new response. Embeddings may also be generated for one or more prior queries, prior responses, and/or prior thread descriptors (collectively “prior embeddings”). At operation 486, the one or more embeddings for the new query and/or the new response are compared to one or more of the prior embeddings. The comparison may be performed in the multi-dimensional vector space of the embeddings. For instance, a cosine similarity or other type of comparison technique may be performed to determine the closeness of the embeddings.

At operation 494, a determination is made, based on the embedding comparison, as to whether a divergence has occurred. For example, if the distance between the compared embeddings is greater than a threshold distance, a divergence may be determined to have occurred. If the distance is below the threshold, a divergence has not occurred (e.g., the new turn remains on topic). If a divergence has occurred, the method 480 flows back to method 450 of FIG. 4B and the updated thread descriptor is generated in operation 454. If no divergence has occurred, method 480 repeats for a next turn in the thread.

Alternatively or additionally, operations 488-492 may be performed to determine the occurrence of a divergence. At operation 488, a divergence prompt is generated that includes the new query and/or the new response along with data associated with prior turns of the thread, such as prior queries, prior responses, and/or prior thread descriptors. The divergence prompt also includes static instructions to instruct the generative AI model to determine whether a divergence has occurred. The static instructions may include examples of divergences and/or a set of factors that should be evaluated in determining whether a divergence has occurred. At operation 490, the divergence prompt is provided to a generative AI model that processes the divergence and generates an output that indicates whether a divergence has occurred. The output is received in operation 492. In some examples, the output is a binary output (e.g., yes/no, I/O) that directly indicates whether a divergence has occurred. In other examples, the output indicates a divergence score that indicates the likelihood of divergence (e.g., 0-100 with 100 indicating a strong likelihood of divergence).

In some examples, a separate divergence prompt is not created beyond the prompt that is used for generating a response to the new query. Instead, the content of the divergence prompt is incorporated into the query-processing prompt. For instance, when a new query is received, the query is incorporated into a query-processing prompt that is processed by the language model (e.g., generative AI model) to generate a response to the query. In examples where the content of the divergence prompt is incorporated into the query-processing prompt, the language model generates both the response to the query and the divergence score or output. The response to the query may be surfaced to the user while the divergence score remains hidden from the user and is instead used in the background for the divergence analysis.

At operation 494, a determination is made, based on the output received in operation 492, as to whether a divergence has occurred. For example, the divergence score is above a threshold or the binary output indicates a divergence, a divergence may be determined to have occurred. If a divergence has occurred, the method 480 flows back to method 450 of FIG. 4B and the updated thread descriptor is generated in operation 454. If no divergence has occurred, method 480 repeats for a next turn in the thread.

Returning to method 450 in FIG. 4B, the method 450 continues with operation 456 where a second thread descriptor is generated for a second thread associated with the user when the second thread is in a first state. The second thread descriptor may be generated similarly to the first thread descriptor for the first thread in operation 452. At operation 458, an updated second thread descriptor is generated for the second thread when the second thread is in a second state (e.g., after one or more turns have occurred after the second thread descriptor was generated). The updated second thread descriptor may be generated similarly to the updated first thread descriptor generated in operation 454. Operation 458 may further include storing the updated second thread descriptor with the second thread.

At operation 460, a user interface is generated with selectable thread elements for the first thread and the second thread. The user interface may be similar to the interface 300 depicted in FIG. 3A. For instance, the generated interface may include a first thread element 302A for the first thread and a second thread element 302B for the second thread. The first thread element includes one or more of the updated first thread descriptors, and the second thread element includes one or more of the updated second thread descriptors.

At operation 462, a selection of one of the thread elements is received. For instance, one of the first thread element 302A or the second thread element 302B may be selected. At operation 464, the thread associated with the selected thread element is opened. As an example, a chat interface may be launched in a side pane of the web browser and the data of the selected thread loaded into the chat interface.

While the techniques and procedures in methods depicted in FIGS. 4A-C are depicted and/or described in a certain order for purposes of illustration, it should be appreciated that certain procedures may be reordered and/or omitted within the scope of various embodiments. The operations of the method described therein may also be performed by one or more components of systems 100 or 200 described above among other types of computing devices.

FIG. 5 is a block diagram illustrating physical components (e.g., hardware) of a computing device 501 with which examples of the present disclosure may be practiced. The computing device components described below may be suitable for one or more of the components of the systems 100, 200 described above. In a basic configuration, the computing device 501 includes at least one processing unit 502 and a system memory 504. Depending on the configuration and type of computing device 501, the system memory 504 may comprise volatile storage (e.g., random access memory), non-volatile storage (e.g., read-only memory), flash memory, or any combination of such memories. The system memory 504 may include an operating system 505 and one or more program modules 506 suitable for running software applications 550 (e.g., applications 112, applications for hosting chat functions, applications for generating thread descriptors) and other applications.

The operating system 505 may be suitable for controlling the operation of the computing device 501. Furthermore, aspects of the disclosure may be practiced in conjunction with a graphics library, other operating systems, or any other application program and is not limited to any particular application or system. This basic configuration is illustrated in FIG. 5 by those components within a dashed line 508. The computing device 500 may have additional features or functionality. For example, the computing device 501 may also include additional data storage devices (removable and/or non-removable) such as, for example, magnetic disks, optical disks, or tape. Such additional storage is illustrated in FIG. 5 by a removable storage device 509 and a non-removable storage device 510.

As stated above, a number of program modules and data files may be stored in the system memory 504. While executing on the processing unit 502, the program modules 506 may perform processes including one or more of the operations of the methods and processes discussed herein, such the methods of FIGS. 4A-4C. Other program modules that may be used in accordance with examples of the present disclosure and may include applications such as electronic mail and contacts applications, word processing applications, spreadsheet applications, database applications, slide presentation applications, drawing or computer-aided application programs, etc.

Furthermore, examples of the disclosure may be practiced in an electrical circuit comprising discrete electronic elements, packaged or integrated electronic chips containing logic gates, a circuit utilizing a microprocessor, or on a single chip containing electronic elements or microprocessors. For example, examples of the disclosure may be practiced via a system-on-a-chip (SOC) where each or many of the components illustrated in FIG. 5 may be integrated onto a single integrated circuit. Such an SOC device may include one or more processing units, graphics units, communications units, system virtualization units and various application functionality all of which are integrated (or “burned”) onto the chip substrate as a single integrated circuit. When operating via an SOC, the functionality, described herein, with respect to detecting an unstable resource may be operated via application-specific logic integrated with other components of the computing device 501 on the single integrated circuit (chip). Examples of the present disclosure may also be practiced using other technologies capable of performing logical operations such as, for example, AND, OR, and NOT, including mechanical, optical, fluidic, and quantum technologies.

The computing device 501 may also have one or more input device(s) 512 such as a keyboard, a mouse, a pen, a sound input device, a touch input device, a camera, etc. The output device(s) 514 such as a display, speakers, a printer, etc. may also be included. The aforementioned devices are examples and others may be used. The computing device 501 may include one or more communication connections 516 allowing communications with other computing devices 518. Examples of suitable communication connections 516 include RF transmitter, receiver, and/or transceiver circuitry; universal serial bus (USB), parallel, and/or serial ports.

The term computer readable media as used herein includes volatile and nonvolatile, removable and non-removable media implemented in any method or technology for storage of information, such as computer readable instructions, data structures, or program modules. The system memory 504, the removable storage device 509, and the non-removable storage device 510 are all computer readable media examples (e.g., memory storage.) Computer readable media include random access memory (RAM), read-only memory (ROM), electrically erasable programmable ROM (EEPROM), flash memory or other memory technology, CD-ROM, digital versatile disks (DVD) or other optical storage, magnetic cassettes, magnetic tape, magnetic disk storage or other magnetic storage devices, or any other article of manufacture which can be used to store information and which can be accessed by the computing device 501. Any such computer readable media may be part of the computing device 501. Computer readable media does not include a carrier wave or other propagated data signal.

Communication media may be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, communication media may include wired media such as a wired network or direct-wired connection, and wireless media such as acoustic, RF, infrared, and other wireless media.

In an aspect, the technology relates to a computer-implemented method for capturing a dynamic state of a thread. The method includes receiving, at an application, a first query for a thread; receiving, at the application, a first response to the first query; generating a first prompt wherein the first prompt includes the first query and the first response for the first query; providing the first prompt to a generative artificial intelligence (AI) model; receiving, from the generative AI model in response to the first prompt, a first thread descriptor representing a first state of the thread; surfacing the first thread descriptor; receiving, at the application, a second query for the thread and a second response to the second query; generating a second prompt wherein the second prompt includes the second query and the second response for the second query; providing the second prompt to the generative AI model; receiving, from the generative AI model in response to the second prompt, a second thread descriptor, representing a second state of the thread; and surfacing the second thread descriptor, wherein the second thread descriptor replaces the first thread descriptor.

In an example, the application is a web browser having a chat interface. In another example, the first prompt further includes grounding data used in generating the first response. In still another example, the second thread descriptor includes at least one of a title for the thread, a synopsis for the thread, or an image for the thread. In a further example, the second thread descriptor is the synopsis for the thread, and the second prompt includes static instructions for generating the synopsis. In yet another example, the second thread descriptor is the image for the thread, and the second prompt includes static instructions for generating the image. In still yet another example, the second thread descriptor includes at least one of a synopsis or title for the thread and the method further includes generating a third prompt including at least the synopsis or title and static instructions for generating an image; providing the third prompt to the generative AI model; and receiving, from the generative AI model, the image as another thread descriptor.

In another example, the thread is a first thread and the method further includes storing the second thread descriptor with the first thread; receiving, at the application, a first query for a second thread; generating a third thread descriptor, representing a state of the second thread, based on at least one of the first query of the second thread or a first response to the first query for the second thread; and storing the third thread descriptor with the second thread. In a further example, the method further includes generating a user interface (UI) including a first selectable UI element representing the first thread, the first selectable UI element including the second thread descriptor; and a second selectable UI element representing the second thread, the second selectable UI element including the third thread descriptor. In still another example, the first selectable UI element further includes a timestamp.

In another aspect, the technology relates to a computer-implemented method for capturing dynamic states of threads. The method includes generating a first thread descriptor for a first thread at a first state after a turn; generating an updated first thread descriptor for the first thread at a second state after a subsequent turn; storing the updated first thread descriptor with the first thread; generating a second thread descriptor for a second thread at a first state after a turn; generating an updated second thread descriptor for the second thread at a second state after a subsequent turn; storing the updated second thread descriptor with the second thread; and generating a user interface including a first selectable user interface (UI) element representing the first thread, the first selectable UI element including the updated first thread descriptor; and a second selectable UI element representing the second thread, the second selectable UI element including the updated second thread descriptor.

In an example, the method further includes receiving a selection of the first selectable UI element; and based on receiving the selecting, opening the thread in the second state. In another example, the method further includes receiving an additional turn to the first thread, thereby forming a third state for the first thread; determining that the additional turn diverges from a prior state of the first thread; based on the additional turn diverging from the first thread, generating a prompt including the updated first thread descriptor and the turn wherein the turn is a query and a response to the query; providing the prompt to a generative AI model; receiving, from the generative AI model in response to the prompt, a new thread descriptor, representing the third state of the first thread; storing the new thread descriptor with the first thread; and surfacing the new thread descriptor, wherein the new thread descriptor replaces the updated first thread descriptor. In another example, determining that the additional turn diverges further includes generating an embedding for the additional turn; and comparing the embedding for the additional turn to one or more embeddings for previous turns within the first thread. In still another example, determining that the additional turn diverges further includes generating a divergence prompt including the additional turn and at least one of a prior query, a prior response, or a prior thread descriptor; providing the divergence prompt to the generative AI model; receiving a divergence output from the generative AI model; and determining that the additional turn diverges based on the divergence output. In yet another example, the first selectable UI element includes at least two of a title, a synopsis, an image, a time stamp, and a thread preview for the first thread. In still yet another example, the first selectable UI element includes at least the title and the image.

In another aspect, the technology relates to a system for generating a dynamic representation for a thread. The system includes at least one processor; and memory storing instructions that, when executed by the at least one processor, cause the system to perform operations. The operations include receive a first input query for the thread; receive, from a first generative artificial intelligence (AI) model, a first response to the first query; generate a first descriptor prompt including at least one of the first input query and the first response; provide the first descriptor prompt to a second generative AI model; receive, from the second generative AI model in response to the first descriptor prompt, a first thread descriptor representative of a first state of the thread; surface the first thread descriptor; receive a second input query for the thread; receive, from the first generative AI model, a second response to the second input query; generate a second descriptor prompt including at least one of the second input query and the second response; provide the second descriptor prompt to the second generative AI model; receive, from the generative AI model in response to the second descriptor prompt, a second thread descriptor representative of a second state of the thread; and surface the second thread descriptor, wherein the second thread descriptor replaces the first thread descriptor.

In an example, the operations further include generate a prompt that includes the second thread descriptor; provide the prompt to an image-generating generative AI model; and receive, from the image-generating generative AI model, an image based on at least the second thread descriptor. In another example, the first thread descriptor includes at least one of a title, a synopsis, or an image.

It is to be understood that the methods, modules, and components depicted herein are merely examples. Alternatively, or in addition, the functionality described herein can be performed, at least in part, by one or more hardware logic components. For example, illustrative types of hardware logic components that can be used include Field-Programmable Gate Arrays (FPGAs), Application-Specific Integrated Circuits (ASICs), Application-Specific Standard Products (ASSPs), System-on-a-Chip systems (SOCs), Complex Programmable Logic Devices (CPLDs), etc. In an abstract, but still definite sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or inter-medial components. Likewise, any two components so associated can also be viewed as being “operably connected,” or “coupled,” to each other to achieve the desired functionality. Merely because a component, which may be an apparatus, a structure, a system, or any other implementation of a functionality, is described herein as being coupled to another component does not mean that the components are necessarily separate components. As an example, a component A described as being coupled to another component B may be a sub-component of the component B, the component B may be a sub-component of the component A, or components A and B may be a combined sub-component of another component C.

The functionality associated with some examples described in this disclosure can also include instructions stored in a non-transitory media. The term “non-transitory media” as used herein refers to any media storing data and/or instructions that cause a machine to operate in a specific manner. Illustrative non-transitory media include non-volatile media and/or volatile media. Non-volatile media include, for example, a hard disk, a solid-state drive, a magnetic disk or tape, an optical disk or tape, a flash memory, an EPROM, NVRAM, PRAM, or other such media, or networked versions of such media. Volatile media include, for example, dynamic memory such as DRAM, SRAM, a cache, or other such media. Non-transitory media is distinct from, but can be used in conjunction with transmission media. Transmission media is used for transferring data and/or instruction to or from a machine. Examples of transmission media include coaxial cables, fiber-optic cables, copper wires, and wireless media, such as radio waves.

Furthermore, those skilled in the art will recognize that boundaries between the functionality of the above-described operations are merely illustrative. The functionality of multiple operations may be combined into a single operation, and/or the functionality of a single operation may be distributed in additional operations. Moreover, alternative embodiments may include multiple instances of a particular operation, and the order of operations may be altered in various other embodiments.

Although the disclosure provides specific examples, various modifications and changes can be made without departing from the scope of the disclosure as set forth in the claims below. Accordingly, the specification and figures are to be regarded in an illustrative rather than a restrictive sense, and all such modifications are intended to be included within the scope of the present disclosure. Any benefits, advantages, or solutions to problems that are described herein with regard to a specific example are not intended to be construed as a critical, required, or essential feature or element of any or all the claims.

Furthermore, the terms “a” or “an,” as used herein, are defined as one or more than one. Also, the use of introductory phrases such as “at least one” and “one or more” in the claims should not be construed to imply that the introduction of another claim element by the indefinite articles “a” or “an” limits any particular claim containing such introduced claim element to containing only one such element, even when the same claim includes the introductory phrases “one or more” or “at least one” and indefinite articles such as “a” or “an.” The same holds true for the use of definite articles.

Unless stated otherwise, terms such as “first” and “second” are used to arbitrarily distinguish between the elements such terms describe. Thus, these terms are not necessarily intended to indicate temporal or other prioritization of such elements.

What is claimed is:

1. A computer-implemented method for capturing a dynamic state of a thread, the method comprising:
receiving, at an application, a first query for a thread;
receiving, at the application, a first response to the first query;
generating a first prompt wherein the first prompt includes the first query and the first response for the first query;
providing the first prompt to a generative artificial intelligence (AI) model;
receiving, from the generative AI model in response to the first prompt, a first thread descriptor representing a first state of the thread;
surfacing the first thread descriptor;
receiving, at the application, a second query for the thread and a second response to the second query;
generating a second prompt wherein the second prompt includes the second query and the second response for the second query;
providing the second prompt to the generative AI model;
receiving, from the generative AI model in response to the second prompt, a second thread descriptor, representing a second state of the thread; and
surfacing the second thread descriptor, wherein the second thread descriptor replaces the first thread descriptor.

2. The computer-implemented method of claim 1, wherein the application is a web browser having a chat interface.

3. The computer-implemented method of claim 1, wherein the first prompt further includes grounding data used in generating the first response.

4. The computer-implemented method of claim 1, wherein the second thread descriptor includes at least one of a title for the thread, a synopsis for the thread, or an image for the thread.

5. The computer-implemented method of claim 4, wherein the second thread descriptor is the synopsis for the thread, and the second prompt includes static instructions for generating the synopsis.

6. The computer-implemented method of claim 4, wherein the second thread descriptor is the image for the thread, and the second prompt includes static instructions for generating the image.

7. The computer-implemented method of claim 1, wherein the second thread descriptor includes at least one of a synopsis or title for the thread and the method further comprises:
generating a third prompt including at least the synopsis or title and static instructions for generating an image;
providing the third prompt to the generative AI model; and
receiving, from the generative AI model, the image as another thread descriptor.

8. The computer-implemented method of claim 1, wherein the thread is a first thread and the method further comprises:
storing the second thread descriptor with the first thread;
receiving, at the application, a first query for a second thread;
generating a third thread descriptor, representing a state of the second thread, based on at least one of the first query of the second thread or a first response to the first query for the second thread; and
storing the third thread descriptor with the second thread.

9. The computer-implemented method of claim 8, further comprising:
generating a user interface (UI) comprising:
a first selectable UI element representing the first thread, the first selectable UI element including the second thread descriptor; and
a second selectable UI element representing the second thread, the second selectable UI element including the third thread descriptor.

10. The computer-implemented method of claim 9, wherein the first selectable UI element further includes a timestamp.

11. A computer-implemented method for capturing dynamic states of threads, the method comprising:
generating a first thread descriptor for a first thread at a first state after a turn;
generating an updated first thread descriptor for the first thread at a second state after a subsequent turn;
storing the updated first thread descriptor with the first thread;
generating a second thread descriptor for a second thread at a first state after a turn;
generating an updated second thread descriptor for the second thread at a second state after a subsequent turn;
storing the updated second thread descriptor with the second thread; and
generating a user interface comprising:
a first selectable user interface (UI) element representing the first thread, the first selectable UI element including the updated first thread descriptor; and
a second selectable UI element representing the second thread, the second selectable UI element including the updated second thread descriptor.

12. The computer-implemented method of claim 11, further comprising:
receiving a selection of the first selectable UI element; and
based on receiving the selecting, opening the thread in the second state.

13. The computer-implemented method of claim 11, further comprising:
receiving an additional turn to the first thread, thereby forming a third state for the first thread;
determining that the additional turn diverges from a prior state of the first thread;
based on the additional turn diverging from the first thread, generating a prompt including the updated first thread descriptor and the turn wherein the turn is a query and a response to the query;
providing the prompt to a generative AI model;
receiving, from the generative AI model in response to the prompt, a new thread descriptor, representing the third state of the first thread;
storing the new thread descriptor with the first thread; and
surfacing the new thread descriptor, wherein the new thread descriptor replaces the updated first thread descriptor.

14. The computer-implemented method of claim 13, wherein the determining that the additional turn diverges further comprises:
generating an embedding for the additional turn; and
comparing the embedding for the additional turn to one or more embeddings for previous turns within the first thread.

15. The computer-implemented method of claim 13, wherein the determining that the additional turn diverges further comprises:
generating a divergence prompt including the additional turn and at least one of a prior query, a prior response, or a prior thread descriptor;
providing the divergence prompt to the generative AI model;
receiving a divergence output from the generative AI model; and
determining that the additional turn diverges based on the divergence output.

16. The computer-implemented method of claim 11, wherein the first selectable UI element includes at least two of a title, a synopsis, an image, a time stamp, and a thread preview for the first thread.

17. The computer-implemented method of claim 16, wherein the first selectable UI element includes at least the title and the image.

18. A system for generating a dynamic representation for a thread, comprising:
at least one processor; and
memory storing instructions that, when executed by the at least one processor, cause the system to perform operations comprising:
receive a first input query for the thread;
receive, from a first generative artificial intelligence (AI) model, a first response to the first query;
generate a first descriptor prompt including at least one of the first input query and the first response;
provide the first descriptor prompt to a second generative AI model;
receive, from the second generative AI model in response to the first descriptor prompt, a first thread descriptor representative of a first state of the thread;
surface the first thread descriptor;
receive a second input query for the thread;
receive, from the first generative AI model, a second response to the second input query;
generate a second descriptor prompt including at least one of the second input query and the second response;
provide the second descriptor prompt to the second generative AI model;
receive, from the generative AI model in response to the second descriptor prompt, a second thread descriptor representative of a second state of the thread; and
surface the second thread descriptor, wherein the second thread descriptor replaces the first thread descriptor.

19. The system of claim 18, wherein the operations further comprise:
generate a prompt that includes the second thread descriptor;
provide the prompt to an image-generating generative AI model; and
receive, from the image-generating generative AI model, an image based on at least the second thread descriptor.

20. The system of claim 18, wherein the first thread descriptor includes at least one of a title, a synopsis, or an image.
